(19) United States
(12) Patent Application Publication
(10) Pub. No.: US 2017/0283577 A1
(43) Pub. Date: Oct. 5, 2017

(54) ELECTROSTATIC DISSIPATING MAT

(71) Applicant: Zeon Chemicals L.P., Louisville, KY (US)

(72) Inventors: Andrew MITTERMILLER, Louisville, KY (US); Clark CABLE, Jeffersonville, IN (US); Zhiyi BAO, Greenwood, IN (US)

(21) Appl. No.: 15/472,682

(22) Filed: Mar. 29, 2017

Related U.S. Application Data
(60) Provisional application No. 62/316,949, filed on Apr. 1, 2016.

(51) Int. Cl. C08K 3/26; C08K 3/36; C08K 3/34; B29C 47/00; H05F 3/02; B29C 43/00; B29C 43/24; B29C 43/30; B29C 35/02; B29B 7/02; C08K 3/22; B29C 47/06

(52) U.S. Cl. CPC C08K 3/26; C08K 3/22; C08K 3/36; C08K 3/34; B29C 47/0004; B29C 47/0021; B29C 47/065; B29C 43/003; B29C 43/24; B29C 43/305; B29C 35/02; B29B 7/02; H05F 3/025; C08K 2003/265; C08K 2003/2241; C08K 2201/001; C08K 2003/2296; B29K 2071/00

(57) ABSTRACT

An electrostatic mat, wherein the mat comprises at least one electrostatic layer, wherein the at least one layer comprises an elastomeric rubber, wherein the elastomeric rubber comprises 20-100 phr elastomeric polyether, wherein the elastomeric polyether comprises 10-75 wt % ethylene oxide, 20-70 wt % epihalohydrin, and 0-10% vinyloxirane. The mat prevents the generation of voltage when it is walked on and/or dissipates the charge that was generated.

### CROSS REFERENCE TO RELATED APPLICATIONS

Noon The present application hereby claims the benefit of the provisional patent application of the same title, Ser. No. 62/316,949, filed on Apr. 1, 2016, the disclosure of which is herein incorporated by reference in its entirety.

### BACKGROUND

Current electrostatic dissipating mat materials use conductive plasticizers which leech out over time. The electrical properties can be inconsistent across a mat due to the dispersion of conductive agent. The testing method and industry requirements have recently changed (2014, ANSI/ESD S20.20) to focus on reducing the voltage generated by flooring, rather than just purely on how quickly it can be dissipated. The standard test STM 97.1 specifies a measurement method for the volume resistance of the mat or flooring and specifies that the volume resistance of the surface layer must be less than 1×10̂9 ohms. The ANSI/ESD S20.20 specification now also outlines that the walking body voltage generated by triboelectric compatibility must be less than 100 volts when tested by STM97.2 for a flooring and footwear system.

Many electrostatic dissipating mats contain additives that prevent the generation of voltage when it is walked on and/ or dissipate the charge that was generated. These additives can migrate to the surface of the mat and be removed by washing, or use, or they may simply degrade over time. These mats must be replaced or re-treated with the electrostatic dissipating additive to maintain their properties.

### BRIEF SUMMARY

An electrostatic mat, wherein the mat comprises at least one electrostatic layer, wherein the at least one layer comprises an elastomeric rubber, wherein the elastomeric rubber comprises 20-100 phr elastomeric polyether, wherein the elastomeric polyether comprises 10-75 wt % ethylene oxide, 20-70 wt % epihalohydrin, and 0-10% vinyloxirane.

### DETAILED DESCRIPTION

It has been found that an electrostatic mat comprising elastomeric rubber has the properties of low tribocharge generation (static voltage created by friction) when walked on and can dissipate any charge that has been generated safely. It has been found that elastomeric rubber can be used in an electrostatic mat without any additives and does not require re-treatment to maintain its properties. The mat may be a single layer of elastomeric rubber or may be multiple layers, wherein at least one layer comprises elastomeric rubber. The electrostatic layer comprising elastomeric rubber may be exclusively elastomeric rubber, it may consist essentially of elastomeric rubber, or elastomeric rubber may be a majority of the layer by weight.

In some embodiments, the electrostatic layer is a layer on one surface of the electrostatic mat. In some embodiments, the electrostatic layer is on both surfaces of the mat. In some embodiments, the electrostatic layer is sandwiched between other layers in the mat.

In some embodiments, the electrostatic layer has a thickness from about 0.1 mm to about 5 cm, such as about 0.1 mm to about 3 cm, about 0.1 mm to about 2 cm, about 0.1 mm to about 1 cm, about 0.1 mm to about 0.5 mm, about 1 cm to about 5 cm, about 2 cm to about 5 cm, about 3 cm to about 5 cm, about 0.5 mm to about 4 cm, about 0.5 mm to about 3 cm, about 0.5 mm to about 2 cm, about 0.5 mm to about 1 cm, about 1 cm to about 4 cm, about 1 cm to about 3 cm, and about 1 cm to about 2 cm. In some embodiments, the mat has a thickness from about 0.1 mm to about 5 cm, such as about 0.1 mm to about 3 cm, about 0.1 mm to about 2 cm, about 0.1 mm to about 1 cm, about 0.1 mm to about 0.5 mm, about 1 cm to about 5 cm, about 2 cm to about 5 cm, about 3 cm to about 5 cm, about 0.5 mm to about 4 cm, about 0.5 mm to about 3 cm, about 0.5 mm to about 2 cm, about 0 5 mm to about 1 cm, about 1 cm to about 4 cm, about 1 cm to about 3 cm, and about 1 cm to about 2 cm.

In some embodiments, the elastomeric rubber is colored, such as by pigment. In some embodiments, the elastomeric rubber is black and is colored by carbon black.

In some embodiments, the mat is for walking or standing on (a walking mat). In some embodiments, the mat is a tabletop mat, shelf liner mat, or used on any surface where static protection is advantageous. The mat may be used in various forms or in various functions. The material may be, for example, used as the surface of a tray or a tray liner in an assembly line or conveyor system where components are assembled that require static protection. Another example is the use of the material in storage containers or nesting boxes where sensitive electronics are kept. The mat may be utilized in all work areas, including assembly, storage, transportation, solvent transfer, explosives handling, or general workspace where static and sparking events would be desirably eliminated.

The elastomeric rubber is vulcanized elastomeric compound. In some embodiments, the elastomeric compound comprises the elastomeric polyether, a filler/plasticizer system, and a cure system. An example elastomeric compound comprises about 20 to about 100 phr (parts per hundred rubber by weight) elastomeric polyether, such as about 50 to about 100 phr and about 80 to about 100 phr elastomeric polyether, blended with other materials such as ethylene propylene diene rubber (EPDM), nitrile rubber (NBR), styrene butadiene rubber (SBR), chloroprene rubber (CR), polyvinyl chloride (PVC), poly methyl methacrylate (PMMA), acrylonitrile butadiene styrene (ABS), or a combination thereof. The filler system may be 0 to about 100 phr mineral filler, such as the range of about 30 to about 70 phr. In some embodiments, the elastomeric rubber consists of the elastomeric polyether.

In some embodiments, the elastomeric compound comprises one or more plasticizer. Examples of plasticizers include, but are not limited to monomeric adipate (“Plasthall 7006” supplied by Hallstar), mixed ether ester (“TP-759” supplied by Hallstar), dibutoxyethoxyethyl adipate (“TP-95” supplied by Hallstar), polyester adipate (“Paraplex G50” supplied by Hallstar), polyester sebacate (“Paraplex G-25” supplied by Hallstar), or any other monomeric or polymeric plasticizer that would reduce hardness, reduce compound Mooney viscocity, or reduce overall cost of the compound by allowing for increased filler levels. Plasticizer loadings may be from 0-50 phr in the elastomeric compound, such as from about 0 to about 20 phr, and from about 0 to about 10 phr. In some embodiments, the plasticizer is dibutoxyethoxyethyl adipate.

In some embodiments, the elastomeric compound comprises one or more filler, such as rubber polymers, mineral fillers, carbon black, and salts. Examples of rubber polymer fillers include, but are not limited to ethylene propylene diene rubber (EPDM), nitrile rubber (NBR), styrene butadiene rubber (SBR), chloroprene rubber (CR), polyvinyl chloride (PVC), poly methyl methacrylate (PMMA), acrylonitrile butadiene styrene (ABS). Examples of mineral filler include, but are not limited to silica, silicate, calcium carbonate, clay, titanium oxide, antimony oxide, and a combination thereof. In some embodiments, the mineral filler comprises silica or silicate. In some embodiments, the filler comprises carbon black. In some embodiments, the elastomeric rubber comprises about 0 to about 100 phr mineral filler, such as about 30 to about 70 phr, about 20 to about 60 phr, and about 30 to about 50 phr. When a salt is used as a filler it may reduce the volume resistivity of the mat. The filler may be modified to adjust the hardness, tensile strength, and tear strength of the mat.

Examples of fillers used in non-black rubber compounds include, but are not limited to: talc, clay, silica, sodium aluminosilicate, calcium carbonate, antimoxy trioxide, titanium dioxide, aluminum trihydrate, and combinations thereof. In some embodiments, the filler comprises silica fillers, such as HiSil 233 (supplied by PPG). In some embodiments, the filler comprises aluminum trihydrate used in the range of about 100 to about 120 phr loading, or antimony trioxide used in the range of about 20 to about 30 phr loading.

Examples of salt fillers include, but are not limited to lithium perchlorate, ammonium perchlorate, sodium trifluoroacetate, quaternary ammonium salt (such as tetrabutylammonium bromide), myristyltrimethylammonium bromide, and combinations thereof. In some embodiments, the salt filler is tetrabutylammonium bromide. In some embodiments, the salt filler is myristyltrimethylammonium bromide at about 3 to about 5 phr loading

In some embodiments, the cure system is a sulfur or peroxide cure system that is used with heat to vulcanize the elastomeric compound to the elastomeric rubber. An example of a sulfur cure system uses 1 phr stearic acid, 3-5 phr activator such as zinc oxide, 1-3 phr 4,4-dithiodimorpholine, 1-5phr thiazole, thiuram, sulfonamide, or carbamate accelerators such as 2-mercaptobenzothiazole, mercaptobenzothiazole disulfide, tetraethylthiuram disulfide, tetramethylthiuram disulfide, tetramethylthiuram monosulfide, N-cyclohexyl-2-benzothiazole sulfenamide, N-t-butyl-2-benzothiazole sulfonamide, 4,4-dithiodimorpholine, and combinations thereof. In some embodiments, the cure system is a peroxide cure, which uses 1 phr stearic acid, 3-5 phr activator such as calcium oxide, 0.5-5 phr peroxide curative such as dicumyl peroxide, dialkyl peroxide, or diacyl peroxide, and 0-10 phr peroxide co-agent such as an acrylate, a triallyl cyanurate, or a modified polybutadiene. In some embodiments, the cure system is a chlorine cure system, which consists 1 phr stearic acid, 3-10 phr acid acceptor such as calcium carbonate, magnesium oxide, magnesium hydroxide, hydrotalcite, or a combination thereof, 0-2 phr 2,4,6-trimercapto-s-triazine, 0-1 phr diphenyl guanidine, and 0-1 phr of treated aromatic sulphonamide. In some embodiments, the cure system comprises sulfur donor curatives and accelerators, such as, zinc oxide activator, stearic acid, 4,4-dithiodimorpholine, and 2 phr 2-mercaptobenzothiazol

In some embodiments, the elastomeric polyether comprises of 10-75 wt % ethylene oxide, 20-70 wt % epihalohydrin, and 0-10% allyl glycidyl ether (AGE) produced in solution by Ziegler-Nata oxirane ring opening polymerization. In some embodiments, the elastomeric polyether comprises about 30 to about 50 wt % ethylene oxide, such as about 40 to about 50 wt %. In some embodiments, the elastomeric polyether comprises about 40 to about 60 wt % epihalohydrin, such as about 45 to about 55 wt %. In some embodiments, the elastomeric polyether comprises about 4 to about 10 wt % AGE, such as about 6 to about 8 wt %. The ranges of the ethylene oxide, epihalohydrin, and AGE can be any combination of the above.

In some embodiments, the elastomeric polyether comprises from about 10 to about 75 wt % ethylene oxide. In some embodiments, the total amount of ethylene oxide in the electrostatic layer comprising elastomeric rubber may be from about 10 to about 40 wt %, such as about 20 to about 75 wt %, and about 30 to about 75 wt %, about 20 to about 65 wt %, about 30 to about 65 wt %, about 20 to about 55 wt %, about 30 to about 55 wt %, about 20 to about 45 wt %, about 30 to about 45 wt %.

Examples of epihalohydrin include, epichlorohydrin, epibromohydrin, epiiodohydrin, and epifluorohydrin. In some embodiments, the epihalohydrin is selected from epichlorohydrin and epibromohydrin. In some embodiments, the epihalohydrin is epichlorohydrin.

The vinyloxirane is a compound that comprises an epoxy ring and a vinyl group. Examples of vinyloxirane include, but are not limited to, allyl glycidyl ether, 2-methyl-2-vinyloxirane, (R)-2-vinyloxirane, 2-vinyloxirane, and 2-phenyl-3-vinyloxirane. The vinyloxirane allows the rubber to be cured by sulfur and peroxide vulcanization. In some embodiments, the vinyloxirane is selected from allyl glycidyl ether, 2-methyl-2-vinyloxirane, (R)-2-vinyloxirane, 2-vinyloxirane, and 2-phenyl-3-vinyloxirane. In some embodiments, the vinyloxirane comprises allyl glycidyl ether.

The elastomeric rubber will have physical characteristics such as hardness, elongation, volume resistance, and tensile strength that will affect its performance as an electrostatic mat. In some embodiments, the elastomeric rubber has a Shore A hardness of about 50 to about 80. In some embodiments, the elastomeric rubber has an elongation of about 100% to about 1500%, such as 200% to about 1200%, about 200% to about 1000%, about 300% to about 800%. In some embodiments, the elastomeric rubber has a volume resistivity of about 10̂5 ohms to about 10̂9 ohms, such as about 10̂5 to about 10̂8 ohms or about 10̂6 to about 10̂7 ohms. In some embodiments, the elastomeric rubber has a tensile strength of about 500 to about 3000 psi, such as about 1200 to about 2500 psi or about 1500 to about 2500 psi.

The walking body voltage is the voltage that is generated by walking on a mat. It is measured using the ANSI/ESD 520.20 STM97.2 standard. In some embodiments, the mat has a walking body voltage of about 5 peak volts to about 500 peak volts, such as about 5 peak volts to about 100 peak volts, and 5 peak volts to about 50 peak volts.

The elastomeric polyether is formed by polymerizing the ethylene oxide, epihalohydrin, and the optional vinyloxirane. The elastomeric compound is made by mixing any fillers, plasticizers, polymer blends, or other additives, and the cure system to the elastomeric polyether. The elastomeric compound is shaped by molding, extrusion, or calendaring, then it is vulcanized or cured to form the elastomeric rubber.

The electrostatic mat may be prepared by conventional methods, using a mixing device such as a rubber mill or an internal mixer. In a typical process, the elastomeric polyether is added to an internal mixer and mixed for about 0.5 to 4 minutes. Processing aids are added to the elastomeric polyether and the mixing is continued for about 2 to 10 minutes. Any fillers, pigments, reinforcing agents, plasticizers or other additives may be added during this mixing cycle to form the master batch.

The master batch is cured, for example by a peroxide curing system such as a metal oxide and organic peroxide, which are added to the master batch to form the elastomeric compound, and mixing is continued for about 3 to 10 minutes. On completion of mixing, the formed compound is formed into sheets on a two-roll mill These sheets can be readily formed into the desired shape or configuration by molding, extruding, or calendaring at temperatures from around 140° C. to around 200° C. Variations of the described process, including different times or temperatures, different orders of addition of ingredients, and the like, are envisioned. The actual process of preparing the formulations is not critical and the above description is illustrative only.

The mat may comprise one or more layers, such as a thin layer of elastomeric rubber adhered to the surface of a conductive but structurally reinforcing and/or lower cost substrate. The mat is then used for electrostatic protection to prevent the buildup and also to safely discharge static electricity due to its low triboelectric surface properties and low surface resistivity.

While the present disclosure has illustrated by description several embodiments and while the illustrative embodiments have been described in considerable detail, it is not the intention of the applicant to restrict or in any way limit the scope of the appended claims to such detail. Additional advantages and modifications may readily appear to those skilled in the art.

### EXAMPLES

### Example 1

A white colored single layer static dissipative mat was prepared by compression molding an elastomeric compound containing 100 phr Hydrin Polymer E (as shown in Table 2), 60 phr ground calcium carbonate filler (“Atomite Whiting”), 10 phr titanium dioxide (“Ti-Pure R-101” supplied by The Chemours Company), 1 phr stearic acid (“Industrene R” supplied by HB Chemical), 3 phr zinc oxide (“Zinc Oxide XFT-H” supplied by Akrochem Corporation), 2 phr tetramethylthiuram disulfide (“Accelerator TMTD” supplied by Akrochem Corporation), 2.5 phr 4,4-dithiodimorpholine (“Accelerator R” supplied by Akrochem Corporation), and 0.5 phr elemental sulfur (“Spider Sulfur” supplied by Hallstar).

The above compound was mixed by open two-roll rubber mill and shaped into preform appropriate for compression molding a sheet of approximately 2 mm thickness. The unvulcanized rubber was vulcanized for 20 minutes at 170° C. at constant heat and pressure resulting in the cured rubber mat.

The rubber mat was allowed to acclimate to 23° C. and 12% relative humidity before testing for volume and surface resistance testing outlined in the ANSI ESD specification. The volume resistance was found to be 120 mega ohms and was consistent across and throughout the rubber mat. The suitable range as known to those skilled in the art of electrostatic protection is 1 mega ohm to 1000 mega ohms, meaning that the rubber mat is well within desirable range to safely dissipate electrostatic.

The rubber mat was then allowed to acclimate to 23° C. and 30% relative humidity before testing for walking voltage as outlined in the ANSI ESD specification. The voltage generated when dress shoes, for example, are worn was found to be 32 volts. The voltage above which an ESD event may occur is 100 V, meaning that the rubber mat is well within desirable range to prevent generation of electrostatic in the manufacturing of electronics.

### Examples 2-5

These examples were produced by open two roll rubber mill mixing and shaped into preform appropriate for compression molding an ASTM slab. The elastomeric compound was vulcanized for 10 minutes at 170° C. at constant heat and pressure in an ASTM D3182 slab mold resulting in a 2 mm thickness and 150 mm by 150 mm length and width cured rubber specimen.

The amounts and ingredients for these examples are shown in Table 1. They are the Hydrin Polymer E (shown in Table 2), acrylonitrile-butadiene rubber (“Nipol DN4555” supplied by Zeon Chemicals), silica (“Hisil 233” supplied by PPG Industries), sodium aluminosilicate (“Zeolex 80” supplied by Huber), calcined clay (“Polyfil 70” supplied by KaMin LLC), calcium carbonate (“Atomite Whiting” supplied by Eager Polymers), stearic acid (“Industrene R” supplied by HB Chemical), zinc oxide (“Zinc Oxide XFT-H” supplied by Akrochem Corporation), tetramethylthiuram disulfide (“Accelerator TMTD” supplied by Akrochem Corporation), 2-Mercaptobenzothiazole (“Accelerator MBT” supplied by Akrochem Corporation), and 4,4-dithiodimorpholine (“Accelerator R” supplied by Akrochem Corporation)

TABLE 1

| | 2 | 3 | 4 | 5 |
|---|---|---|---|---|
| Hydrin Polymer E | | 30.00 | 60.00 | 100.00 |
| NIPOL DN4555 | 100.00 | 70.00 | 40.00 | |
| Hisil 233 | 30.00 | 30.00 | 30.00 | 30.00 |
| Carbowax 3350 | 1.00 | 1.00 | 1.00 | 1.00 |
| Stearic Acid | 1.00 | 1.00 | 1.00 | 1.00 |
| Kadox 911C | 3.00 | 3.00 | 3.00 | 3.00 |
| TMTD | 1.00 | 1.00 | 1.00 | 1.00 |
| MBT | 2.00 | 2.00 | 2.00 | 2.00 |
| DTDM | 2.00 | 2.00 | 2.00 | 2.00 |
| TOTAL | 140.00 | 140.00 | 140.00 | 140.00 |
| Hardness A, (pts) | 72 | 70 | 68 | 68 |
| Tensile, (psi) | 3256 | 3169 | 2923 | 2571 |
| Elongation, (%) | 554 | 541 | 535 | 709 |
| Tear Strength, (ppi) | 68.2 | 73.1 | 40.9 | 56.2 |
| Resistance, | 2.7E+10 | 2.5E+08 | 2.6E+07 | 1.0E+07 |
| (23C/12% RH) | | | | |

Examples shown in Table 1 compare the effects of elastomeric polyether content in the elastomeric rubber, from 0 to 100 phr. Example 2 in Table 1 demonstrates that Ophr elastomeric polyether will produce a compound that does not adequately dissipate the static from the mat surface, as shown by the high electrical resistance. Composition with 60-100 phr elastomeric polyether, and 100 phr elastomeric polyether show lower electrical resistance and dissipate static better.

Physical properties of the example compositions were measured based on ASTM D 412 for testing of rubber materials. The hardness was measured by durometer at room temperature by ASTM D 2240 and is reported as Shore A hardness, while the tensile and elongation was measured by ASTM D 412 and are shown in pounds per square inch tensile strength at break and percent elongation at break. Physical properties were measured by a United Model MS tensile tester. These values describe the hardness and physical strength of the matting material and relate to usefulness and durability.

Tear strength was also measured and is shown, as measured by ASTM D 624 Type T, or trouser tear, where a cut is made in a cured slab sample of the rubber and the two separate sides are then pulled in opposing direction. The mean force required to propagate the tear in the rubber sample divided by the thickness of the rubber is reported as pounds per inch. A higher force required to tear the rubber is desirable as it relates to its resistance to tearing and thus its durability in use.

The rubber mat sample in each example was allowed to acclimate to 23° C. and 12% relative humidity before testing for volume resistance testing outlined in the ANSI/ESD STM 7.1 specification which requires volume resistance to be less than 1×10̂9 ohms to safely and effectively dissipate static in work surfaces and flooring.

TABLE 2
Hydrin Polymer Composition

| Hydrin Polymer | epichlorohydrin | ethylene oxide | allyl glycidyl ether |
|---|---|---|---|
| A | 92.3 | 0 | 7.7 |
| B | 74.4 | 14.6 | 11 |
| C | 71.8 | 22.6 | 5.6 |
| D | 64.5 | 30.5 | 5 |
| E | 50 | 43 | 7 |
| F | 66.6 | 33.7 | 0 |

### Example 6-10

Examples shown in Table 3 show comparison of using elastomeric polyether with various level of the ethylene oxide monomer. Example 1 shows insufficient static dissipative properties due to the low ethylene oxide content, while examples 2 through 5 show the material is below the resistance limit for ESD safety. Elastomeric polyethers with ethylene oxide contents above 30 wt % make an elastomeric rubber that can more readily and safely ground the electrostatic.

TABLE 3

| | 6 | 7 | 8 | 9 | 10 |
|---|---|---|---|---|---|
| Hydrin Polymer A | 100.00 | | | | |
| Hydrin Polymer B | | 100.00 | | | |
| Hydrin Polymer C | | | 100.00 | | |
| Hydrin Polymer D | | | | 100.00 | |
| Hydrin Polymer E | | | | | 100.00 |
| Hisil 233 | 30.00 | 30.00 | 30.00 | 30.00 | 30.00 |
| Carbowax 3350 | 1.00 | 1.00 | 1.00 | 1.00 | 1.00 |
| Stearic Acid | 1.00 | 1.00 | 1.00 | 1.00 | 1.00 |
| Kadox 911C | 3.00 | 3.00 | 3.00 | 3.00 | 3.00 |
| TMTD | 1.00 | 1.00 | 1.00 | 1.00 | 1.00 |
| MBT | 2.00 | 2.00 | 2.00 | 2.00 | 2.00 |
| DTDM | 2.00 | 2.00 | 2.00 | 2.00 | 2.00 |
| TOTAL | 140.00 | 140.00 | 140.00 | 140.00 | 140.00 |
| Hardness A, (pts) | 67 | 69 | 67 | 65 | 68 |
| Tensile, (psi) | 2360 | 2442 | 2880 | 2673 | 2571 |
| Elongation, (%) | 632 | 585 | 738 | 737 | 709 |
| Tear Strength, (ppi) | 54.6 | 32.6 | 91.1 | 61.8 | 56.2 |
| Resistance, | 4.3E+09 | 4.4E+08 | 1.2E+08 | 4.0E+07 | 1.0E+07 |
| (23C/12% RH) | | | | | |

### Examples 11-14

Examples shown in Table 4 illustrate the effect of various mineral fillers in the elastomeric rubber. The filler type gives the vulcanized article physical strength. The silica type fillers, here in Example 12, provide elastomeric rubber with considerable higher tensile and tear strength.

TABLE 4

| | 11 | 12 | 13 | 14 |
|---|---|---|---|---|
| Hydrin Polymer E | 100.00 | 100.00 | 100.00 | 100.00 |
| Zeolex 80 | 30.00 | | | |
| Hisil 233 | | 30.00 | | |
| Atomite Whiting | | | 30.00 | |
| POLYFIL 70 | | | | 30.00 |
| Carbowax 3350 | 1.00 | 1.00 | 1.00 | 1.00 |
| Stearic Acid | 1.00 | 1.00 | 1.00 | 1.00 |
| Kadox 911C | 3.00 | 3.00 | 3.00 | 3.00 |
| TMTD | 1.00 | 1.00 | 1.00 | 1.00 |
| MBT | 2.00 | 2.00 | 2.00 | 2.00 |
| DTDM | 2.00 | 2.00 | 2.00 | 2.00 |
| TOTAL | 140.00 | 140.00 | 140.00 | 140.00 |
| Hardness A, (pts) | 58 | 68 | 50 | 52 |
| Tensile, (psi) | 1026 | 2571 | 425 | 576 |
| Elongation, (%) | 514 | 709 | 443 | 401 |
| Tear Strength, (ppi) | 20.4 | 56.2 | 11.5 | 20.7 |
| Resistance, | 1.3E+07 | 1.0E+07 | 8.7E+06 | 1.0E+07 |
| (23C/12% RH) | | | | |

### Examples 15-18

Examples shown in Table 5 compare cure systems used to vulcanize the elastomeric compound. Example 15 used a sulfur donor vulcanization system. Examples 16 and 18 used a triazine cure system of magnesium oxide (“Maglite D” supplied by Hallstar), 2,4,6-trimercapto-s-triazine (“Zisnet F-ET” supplied by Zeon Chemicals), diphenyl guanidine (“Accelerator DPG” supplied by Akrochem), and an aromatic sulfonamide (“Retarder SAFE” supplied by Akrochem). Example 17 uses a peroxide based vulcanization system of calcium oxide (“Calcium Oxide HP” by Hallstar), dicumyl peroxide (“Vulcup 40KE” by Arkema), and ethylene glycol dimethacrylate (“SR 206” by Sartomer).

A sulfur based cure system as shown in Example 15 provides high strength physical properties and low volume resistance.

Example 18, as compared to example 16, shows the difference in properties of elastomeric rubber with and without allyl glycidyl ether.

TABLE 5

| | 15 | 16 | 17 | 18 |
|---|---|---|---|---|
| Hydrin Polymer E | 100.00 | 100.00 | 100.00 | |
| Hydrin Polymer F | | | | 100.00 |
| Hisil 233 | 30.00 | 30.00 | 30.00 | 30.00 |
| Atomite Whiting | | 5.00 | | 5.00 |
| Carbowax 3350 | 1.00 | 1.00 | 1.00 | 1.00 |
| Stearic Acid | 1.00 | 1.00 | 1.00 | 1.00 |
| Kadox 911C | 3.00 | | | |
| Maglite D | | 2.00 | | 2.00 |
| Calcium Oxide | | | 5.00 | |
| TMTD | 1.00 | | | |
| MBT | 2.00 | | | |
| DTDM | 2.00 | | | |
| Zisnet F-ET | | 0.80 | | 0.80 |
| DPG | | 0.50 | | 0.50 |
| Retarder Safe | | 0.30 | | 0.30 |
| Vulcup 40KE | | | 2.00 | |
| SR 206 | | | 2.00 | |
| TOTAL | 140.00 | 140.60 | 141.00 | 140.6 |
| Hardness A, (pts) | 68 | 68 | 81 | 66 |
| Tensile, (psi) | 2571 | 1512 | 867 | 2228 |
| Elongation, (%) | 709 | 596 | 86 | 759 |
| Tear Strength, (ppi) | 56.2 | 48.2 | 7.0 | 72.7 |
| Resistance, | 1.0E+07 | 6.1E+07 | 3.5E+08 | 1.7E+08 |
| (23C/12% RH) | | | | |

What is claimed is:

1. An electrostatic mat, wherein the mat comprises at least one electrostatic layer, wherein the at least one layer comprises an elastomeric rubber, wherein the elastomeric rubber comprises 20-100 phr elastomeric polyether, wherein the elastomeric polyether comprises 10-75 wt % ethylene oxide, 20-70 wt % epihalohydrin, and 0-10% vinyloxirane.

2. The mat of claim 1, wherein the elastomeric rubber has a Shore A hardness of about 50 to about 80.

3. The mat of claim 1, wherein the elastomeric rubber has an elongation of about 100% to about 1500%.

4. The mat of claim 1, wherein the elastomeric rubber has a volume resistance of about 10̂5 ohms to about 10̂9 ohms.

5. The mat of claim 1, wherein the elastomeric rubber has a tensile strength of about 500 to about 3000 psi.

6. The mat of claim 1, wherein the electrostatic layer has a thickness from about 0.1 mm to about 5 cm.

7. The mat of claim 1, wherein the elastomeric rubber comprises fillers selected from NBR, EPDM, SBR, CR, PVC, PMMA, ABS, and combinations thereof.

8. The mat of claim 1, wherein the elastomeric polyether comprises vinyloxirane.

9. The mat of claim 8, wherein the vinyloxirane comprises allyl glycidyl ether.

10. The mat of claim 1, wherein the epihalohydrin is epichlorohydrin.

11. The mat of claim 9, wherein the epihalohydrin is epichlorohydrin.

12. The mat of claim 1, wherein the elastomeric polyether comprises about 30 to about 75 wt % ethylene oxide, about 40 to about 60 wt % epihalohydrin, and about 4 to about 10 wt % allyl glycidyl ether.

13. The mat of claim 1, wherein the system used to cure the elastomeric rubber is selected from sulfur and sulfur donor curatives.

14. The mat of claim 1, wherein the elastomeric rubber has a walking body voltage generation of about 5 volts to about 500 volts as measured by ANSI/ESD 520.20 STM97.2.

15. A method for producing an electrostatic mat comprises the steps of:
a) polymerizing 10-75 wt % ethylene oxide, 20-70 wt % epihalohydrin, and 0-10% vinyloxirane to form an elastomeric polyether,
b) mixing the elastomeric polyether with a curative to form an elastomeric compound,
c) forming the elastomeric compound into a sheet, and
d) vulcanizing the elastomeric compound to form an elastomeric rubber.

16. The method of claim 15, wherein the mat comprises more than one layer.

17. The method of claim 16, wherein the steps additionally comprise the step of:
d) molding, extruding, or calendaring the elastomeric rubber with at least one additional layer.

18. The method of claim 15, wherein fillers are added to the elastomeric polyether before curing.

19. The method of claim 15, wherein the elastomeric polyether comprises vinyloxirane and the vinyloxirane comprises allyl glycidyl ether.

20. The mat of claim 15, wherein the epihalohydrin is epichlorohydrin.
